(19) United States
(12) Patent Application Publication
(10) Pub. No.: US 2023/0295880 A1
(43) Pub. Date: Sep. 21, 2023

(54) TISSUE PAPER PRODUCTS, ROLLS AND STACKS OF TISSUE PAPER PRODUCTS, AND MANUFACTURING METHODS

(71) Applicant: Essity Hygiene and Health Aktiebolag, Goteborg (SE)

(72) Inventor: Sébastien Jeannot, Kunheim (FR)

(21) Appl. No.: 18/013,817

(22) PCT Filed: Jul. 3, 2020
(86) PCT No.: PCT/IB2020/000592

§ 371 Date: Dec. 29, 2022

(51) Int. Cl. D21H 27/40; A47K 10/16; D21H 27/00; D21H 27/32; D21H 27/02

(52) U.S. Cl. CPC D21H 27/40; A47K 10/16; D21H 27/004; D21H 27/32; D21H 27/02; B31F 1/07

(57) ABSTRACT

Disclosed is a tissue paper product, including between two and four plies, including at least a first ply and a second ply, the two plies, three plies, or four plies being ply-bonded, to form the tissue paper product, the first ply and the second ply being the outermost plies of the tissue paper product, a grammage of the tissue paper product being in a range of 24 to 50 g/m² if a total number of plies of the tissue paper product is 2, in a range of 34 to 65 g/m² if a total number of plies of the tissue paper product is 3, and in a range of 55 to 95 g/m² if a total number of plies of the tissue paper product is 4, the first ply being a structured paper ply.

### CROSS REFERENCE TO RELATED APPLICATIONS

This application is a National Stage application of PCT/IB2020/000592, filed Jul. 3, 2020, which is incorporated by reference in its entirety herein.

### TECHNICAL FIELD

The present disclosure relates to a tissue paper product, such as household towel or toilet paper, comprising a least two plies, wherein the outermost plies of the tissue paper product are embossed. The disclosure also relates to a roll of such a tissue paper product and to a stack of such a tissue paper product. Moreover, the disclosure relates to methods of manufacturing the same.

### TECHNICAL BACKGROUND

In the following, a “tissue paper product” relates to an absorbent paper based on cellulose wadding. The latter is also referred to as a tissue paper base-sheet in this field of technology.

Fibres contained in a tissue paper product are mainly cellulosic fibres, such as pulp fibres from chemical pulp (e.g. Kraft or sulphite), mechanical pulp (e.g. ground wood), thermo-mechanical pulp, chemo-mechanical pulp and/or chemo-thermo-mechanical pulp (CTMP). Pulps derived from both deciduous (hardwood) and coniferous (softwood) can be used. Fibres may also come from non-wood plants, e.g., cereal, bamboo, jute, and sisal. The fibres or a portion of the fibres may be recycled fibres, which may belong to any or all of the above categories. The fibres can be treated with additives, e.g. fillers, softeners, such as, but not limited to, quaternary ammonium compounds and binders, conventional dry-strength agents, temporary wet strength agents or wet-strength agents, in order to facilitate the original paper making or to adjust the properties thereof. The tissue paper product may also contain other types of fibres, e.g., regenerated cellulosic fibres or synthetic fibres for enhancing, for instance, strength, absorption, smoothness or softness of the tissue paper product.

Whenever reference is made to the “softness” of a tissue paper product in this text, reference is made to the property of softness as determined through an evaluation by panel members. A panel of ten members was used in this case. Panel lists are used to rank products in terms of softness. Softness Panel values are used as comparative values enabling a comparison between tested samples. The softer the product/tissue paper product is, the higher the rated value. The softness scale was in the present case set from 0 to 2.5 (2.5 being the highest value). Each sample is composed of one product, i.e., a tissue paper product. Alternatively, each sample is a ply. Samples are first conditioned for a minimum of two hours in a controlled area at 23° C. and 50% relative humidity. Then, evaluation by the panel members takes place.

Tissue paper products may be used for personal and household use as well as for commercial and industrial use. They may be adapted to absorb fluids, remove dust, and for other cleaning purposes. If tissue paper is to be made out of pulp, the process essentially comprises a forming step that includes a headbox- and a forming wire section, and a drying section, either through air drying or conventional drying on a Yankee cylinder. The production process may also include a crepe and, finally, typically a monitoring and winding step.

Several plies may be combined together by a combining operation of a chemical nature (e.g., by adhesive bonding), or of a mechanical nature (e.g., by knurling or so-called edge-embossing), or a combination of both.

Further, the processing to finished tissue product may involve, e.g., longitudinal cut, folding, cross cut, etc. Moreover, individual tissue products may be positioned and brought together to form stacks, which may be individually packaged. Such processing steps may also include application of substances like scents, lotions, softeners or other chemical additives.

When several plies are combined together using adhesive bonding, a film of adhesive is deposited over some or all of the surface of at least one of the plies, then the adhesive-
treated surface is placed in contact with the surface of at least one other ply. Additionally or as an alternative thereto, at least some bonding can also be carried out using water instead of some other adhesive.

When several plies are combined together using mechanical bonding, the plies may be combined by knurling, by compression, by edge-embossing, union embossing and/or ultrasonic.

Mechanical and adhesive bonding may also be combined to combine several plies.

The processing step from the base tissue to a finished tissue paper product occurs in processing machines (converting machines) which include operations such as unwinding the base tissue, calendaring of the tissue, laminating, printing or embossing together to form a multi-ply product.

Embossing can be used to change the shape of a ply from flat to shaped, so that there are areas that are raised and/or recessed from the rest of the surface. It therefore constitutes a deformation of the previously flat sheet, and results in a ply having a particular relief. Usually, the thickness of the ply or of the multiple plies is increased after embossing compared with its initial thickness.

An embossing process is carried out between an embossing roll and a counter roll. The embossing roll can have protrusions or depressions on its circumferential surface leading to embossed protrusions/depressions in the paper web. Counter rolls may be softer than the corresponding embossing roll and may consist of rubber, such as natural rubber, or plastic materials, paper or steel. If the counter roll is made of a softer material like rubber, a contact area/nip can be formed between the embossing roll (e.g., steel roll) and the counter roll by the deformation of the softer roll.

By embossing, a pattern can be applied to a tissue paper fulfilling a decorative and/or functional purpose. A functional purpose may be to improve the properties of the hygiene paper product, that is, the embossment may improve the product thickness, absorbency, bulk, softness, etc. A functional purpose may also be to provide a joint to another ply in a multi-ply product.

Another type of embossment is referred to herein as a “pre-embossment”. A pre-embossment could preferably be applied to a web or ply prior to its joining to the other plies of a multi-ply tissue product.

Such pre-embossment may be made for a functional purpose e.g. as laid out in the above to increase the thickness of the ply, the absorbency, bulk and/or softness.

“Micro-embossment” is used herein for an embossment pattern with a dense configuration. Typically, the micro-embossment may comprise dots in the range 25 to 120 dots per cm², optionally 40 to 100 dots per cm², or 50 to 80 dots per cm². A micro-embossment may advantageously be a pre-embossment. The micro-embossed dots may have different relatively simple surface shapes such as circles, ovals, squares, rectangles or diamonds.

Although the multi-ply tissue paper products and methods for production thereof proposed in the past may be very useful in many applications, there is still a need for improvements. Such improvements would be desirable particularly with respect to the thickness, the strength, the softness, the bulkiness, and/or the absorption capacity of the multi-ply tissue products.

There is, hence, a desire for an improved tissue paper product with at an improvement in at least one of the above-mentioned properties, and for a manufacturing method for such a product.

### SUMMARY

Aspects of the above-mentioned object are achieved by a tissue paper product in accordance with the present disclosure.

One aspect of this disclosure relates to a tissue paper product, such as toilet paper or household towel, wherein the tissue paper product comprises between two and four plies. These two, three, or four plies include at least a first ply and a second ply, and the two plies, three plies, or four plies are ply-bonded, optionally using an adhesive such as lamination glue or mechanical bonding, such as edge embossing, to form the tissue paper product. the first ply and the second ply being the outermost plies of the tissue paper product.

A grammage of the tissue paper product is in a range of 24 to 50 g/m² if a total number of plies of the tissue paper product is 2, in a range of 34 to 65 g/m² if a total number of plies of the tissue paper product is 3, and in a range of 55 to 95 g/m² if a total number of plies of the tissue paper product is 4.

Whenever reference is made to the “grammage” (or “basis weight”) in this text, reference is made to the basis weight (grammage) as determined by a test method following the principles set forth in standard EN ISO 12625-6:2016 for determining the basis weight. Test pieces of 50 cm² are punched from the sample sheet. Test pieces are chosen randomly from the entire sample and should be free of folds, wrinkles and any other deviating distortions. The pieces are conditioned at 23° C., 50% RH (Relative Humidity) for at least 2 hours. A pile of 20 pieces is weighed on a calibrated balance. The basis weight (grammage) is the weighed mass divided by the total area 1000 cm² (20×50cm²) and recorded as mean value with standard deviations.

The first ply is a structured paper ply, such as a ply made of TAD, UCTAD, eTAD, Atmos, or NTT. The first ply has been embossed with a heated embossing roll. The first ply may be the top ply or the bottom ply, depending on the embodiment of the tissue paper product.

The embossing of the first ply with a heated embossing roll may be advantageous as the embossments may have a better shape memory, i.e., they may be more resilient against shape deformation when the tissue paper product is wet. That is, the embossments being less affected when the ply is wet. This means that the tissue paper product may have a better absorption capacity than a comparable tissue paper product which does not comprise at least one ply that was embossed using a heated embossing roll. Moreover, as compared to a product without a ply that was embossed using a heated embossing roll with a certain thickness and strength (tensile strength), a higher thickness may be reached while retaining the same tensile strength. In other words, the tissue paper product in accordance with the present disclosure has high thickness and good absorption properties, as well as a high tensile strength. In particular, with the same embossing load during a manufacturing process, a higher thickness of the tissue product may be reached.

Whenever reference is made to the “absorption capacity” in this text, reference is made to an absorption capacity measured as follows. The measurements are carried out using the basket immersion method. A test sample with a defined width and total mass is placed in a cylindrical basket which is dropped from a defined height over a water surface with deionized water in accordance with ISO 14487 (conductivity 0.25 mS/m at 25 C). The time is measured between when the basket is dropped until the test sample is fully wet. The average time recorded for a number of samples is the equated to the water absorption time. The amount of absorbed water is determined from the dry and wet weight of the test sample. Previous to the measurement, the test samples are to be conditioned a sufficient time under 23° C. and 50% relative humidity (see ISO 187-standard atmosphere for conditioning and testing tissue). The resulting water absorption capacity is reported in grams water per gram test piece to the nearest 0.1 g/g. The method is carried out in accordance with ISO 12625-8:2011 (water-absorption time and water-absorption capacity, basket-immersion test method).

Whenever reference is made to the “thickness” in this text, reference is made to the thickness as obtained in accordance with European standard EN 12625-3 using the Frank Thickness Gauge equipment (Model 16502) or the like. The tissue paper sheet to be measured is cut into pieces of minimum 80 mm in any direction and the pieces are conditioned at 23° C., 50% RH (Relative Humidity) for at least 2 hours. During measurement a sample piece is placed between a fixed bottom plate and a pressure foot. The pressure foot is then lowered at a speed of 2.0 mm/s. The thickness value for the sheet is then read after the pressure value is stabilized. The diameter of the pressure foot is 35.7 mm. The lower plate dimension is minimum 20% bigger. The pressure applied is 2.0 kPa during the measurement.

Whenever reference is made to a “tensile strength” in this text, the tensile strengths in question can be measured and compared as dry tensile strengths following the standard EN ISO 12625-4:2005 or as wet tensile strengths following the standard ISO 12625-5:2005.

The dry strength is determined according to EN ISO 12625-4: 2005, Tissue Paper and Tissue Products, Part 4: Determination of width-related breaking strength, elongation at break and tensile energy absorption. For exemplary purposes, the tensile tester used for the measurement featured two clamps of 50 mm width. Each clamp can grip the test piece firmly, but without damage, along a straight line across the full width of the test piece (the clamping line). The distance between the clamping lines was set at 100 mm. For special tests, the distance is reduced if the available length of the sample is lower than 100 mm (e.g., toilet tissue in cross direction). The tissue paper product to be measured, i.e., two sheets of a single-ply or multi-ply product, was cut into test pieces of 50 mm wide with parallel edges. Each sheet was cut into two different types of test pieces by cutting in the machine direction and in the cross direction. The obtained test pieces were then conditioned in an atmosphere of 23° C., 50% RH (Relative Humidity) for at least 4 hours. The test piece to be measured was placed between the clamps without any strain, and such that any observable slack is eliminated. At the beginning, a pre-tensile force of 25 cN is applied (zero of stretch) then the elongation rate between the clamps was kept constant at 5 cm/min. The maximum tensile force required to break the test piece was obtained. The measurement was repeated with six test pieces and the values obtained were averaged. The dry tensile strength was calculated by means of the following formula: Mean dry tensile strength [N/m]=(mean maximum tensile force [N]/initial width of the test piece [mm])×10<3.

The wet strength was determined according to EN ISO 12625-5 Tissue Paper and Tissue Products, Part 5: determination of width-related wet load at break, 2005. (optionally the following description which follows the principles of the DIN NORM). For exemplary purposes, when experimentally verifying the wet strength of a product, the tensile test was accordingly performed by means of an electronic tensile test apparatus (Model 1122, Instron Corp., Canton, Mass., USA) with a constant rate of elongation of 50 mm/min using a Finch device. To prepare the test strips, 6 samples each having a length of 150 mm and a width of 50 mm were cut from the raw tissue (single ply) prepared in such a manner that the longitudinal direction of the test strips coincided with the machine direction (MD) or cross-direction (CD). The free clamping length when using the Finch clamp was about 50 mm. The test strip was secured with both ends in a clamp of the test apparatus. The other end (loop) formed in this way was placed around a pin and treated at 23° C. with distilled water until complete saturation. The depth of immersion of the loop formed by the test strip is at least 20 mm. The soaking duration (immersion time) is 15 s, the rate of elongation is set to a constant (50±2) mm/min, the measurement of the breaking strength is performed on the sample immersed in distilled water. Six test strips at a time were measured, the result being indicated as an arithmetic mean. To ensure that the wet strength of the samples has fully developed, which is particularly necessary in the case of samples in which additional wet-strength agents were used to boost wet strength, e.g., by their addition in the mass, the samples to be tested were always artificially aged before conducting the tensile test. Aging was effected by heating the samples in an air-circulating drying cabinet to (80±1)° C. for a period of 30 min. Six test strips at a time were measured, the result being indicated as an arithmetic mean.

The thickness of the tissue paper product may be particularly increased due to the choice of a structured ply as a first ply, which is a ply with an increased thickness, as well as the heat-embossing of the ply, which additionally promotes increased thickness.

The tissue paper products in accordance with the present disclosure may have similarly high thicknesses as comparative products, in which top and bottom plies are structured paper plies, which were both not heat-embossed (but which are otherwise manufactured analogously), due to the fact that the structured paper ply has been heat-embossed, while they may at the same time be cheaper to manufacture.

The tissue paper product may in particular be a toilet paper. However, also other tissue paper products are covered, for example, hand towels, napkins, facial tissues, toilet paper, etc.

If ply-bonding with an adhesive is used, the adhesive may, e.g., be a polyvinyl alcohol and/or a methyl cellulose based adhesives. An adhesive may, for example, be applied based on spraying equipment.

The first ply may comprise two types of embossments and may have been processed using “double height embossing” whereby one or several rolls with embossing protrusions having different heights were used. Double height embossing may not only serve to provide bulk to the fibrous product but also to provide an improved optical appearance to the product. The optical appearance can be improved by combining embossing and coloring steps. Another reason for embossing is to generate higher absorbency or improved perceived softness.

Tissue paper products in particular for use as hygiene or wiping products primarily include all kinds of dry-creped tissue paper, wet-creped paper, TAD-paper (Through Air Drying), tissue paper based on structured technologies such as ATMOS®, NTT, UCTAD and cellulose or pulp-wadding, or combinations, laminates or mixtures thereof. Typical properties of these hygiene and wiping products include the ability to absorb tensile stress energy, their drapability, good textile-like flexibility, properties which are frequently referred to as bulk softness, a high surface softness and a high specific volume with a perceptible thickness. A liquid absorbency as high as possible and, depending on the application, a suitable wet and dry strength as well as an appealable visual appearance of the outer product's surfaces are desired. These properties, among others, allow these hygiene and wiping products to be used, for example, as cleaning wipes such as windscreen cleaning wipes, industrial wipes, kitchen paper or the like; as sanitary products such as, for example, bathroom tissue, handkerchiefs, household towels, towels and the like; as cosmetic wipes such as for example facials and as serviettes or napkins, etc. Furthermore, the hygiene and wiping products can be dry, moist, wet, printed or pre-treated in any manner. In addition, the hygiene and wiping products may be folded, interleaved or individually placed, stacked or rolled, connected or not, in any suitable manner.

According to some embodiments, the first ply has been embossed with a heated first embossing roll heated to a temperature in the range of 80° C. to 170°, optionally 100° C. to 165°, 110° C. to 165°, 120° C. to 160°, or 130° C. to 155°.

The first embossing roll that was used to emboss the first ply may be heatable to a surface temperature in the range of 80° C. to 170°, optionally 100° C. to 165°, 110° C. to 165°, 120° C. to 160°, or 130° C. to 155°. These temperature ranges may to an increasing degree with narrower ranges promote the manufacturing of a tissue paper product with good shape memory and/or large thickness, high machine direction (MD) and/or cross direction (CD) tensile strength, and good absorption properties.

The references to the temperatures of the heatable embossing roll(s) in this text are references, in particular, to surface temperatures of the embossing roll. These may be measured, for example, using an infrared thermometer. Moreover, the temperature values refer to temperatures in the steady state of the manufacturing apparatus, i.e., not while running and while plies are in contact with the embossing rolls. In particular, the surface temperature of the heatable embossing roll may drop during manufacturing, due to various effects such as heat conduction to the ply in contact with the roll, etc. For example, a surface temperature of 170° C. might be measured in the steady state (when the embossing roll is not in contact with a ply), and this temperature might decrease to a temperature in the range of 100° C. to 130° C. during manufacturing, etc. In other words, while the manufacturing is taking place, there may be variations in temperature.

To summarize regarding the indicating of temperatures used to heat-emboss the first ply, the temperatures may thus be referred to as “steady-state” temperatures, i.e., temperatures pertaining to a state in which the embossing roll is heated, but manufacturing is not running (the embossing roll is not in contact with a ply).

According to some embodiments, the first ply comprises micro-embossments with a micro-embossment height in a range of 0.1 mm to 1.2 mm.

According to some embodiments, the first ply comprises macro-embossments with a macro-embossment height in a range of 0.2 mm to 2.0 mm, optionally 0.8 mm to 1.4 mm. The first ply may, in particular, comprise micro-embossment and macro-embossments. The density of the total number of embossments of the first ply may be in a range of from 25 to 120 dots/cm², optionally 40 to 100 dots/cm², or 50 to 80 dots/cm². These densities may, to an increasing degree for narrower ranges, promote high tensile strength and good absorption capacities of the respective tissue paper product.

According to embodiments, an embossing density may be measured, e.g., using 3D tomography (for example, using Alicona Infinite Focus SL with the software IF-MeasureSuite Version 5.1). Alicona Infinite Focus SL with the software IF-MeasureSuite Version 5.1 may also be used to measure a surface area that has been embossed and/or an embossment height. The embossment height may be defined as a distance from a bottom of the ply to a top of the ply in sectional view.

The macro-embossments may cover between 1% and 20% of a total surface of the first ply, optionally between 2% and 10%, or between 3% and 6%. The macro-embossments may be provided with a density of 15 dots/cm² or less, optionally 10 dots/cm² or less.

According to some embodiments, the first ply has been moistened, prior to the step of embossing the first ply, with a liquid, such as water with or without one or several additives. The first ply may be moistened with an amount of liquid in the range of 2% to 12% of the basis weight of the first ply, or optionally 4% to 10% of the basis weight of the first ply, prior to being embossed. Analogous statements hold with respect to the second ply.

According to some embodiments, the first ply has not been moistened with a liquid prior to the step of embossing. In these cases, the first ply may also be referred to as a dry heat-embossed ply.

According to some embodiments, the second ply is made of Conventional Wet Press (CWP) paper. Producing a ply from paper-making fibers according to “Conventional Wet Paper” (CWP) processing may, e.g., rely on the manufacturing of “Dry Creped Tissue” or “Wet Crepe Tissue” and is to be distinguished from a “Process for Structured Tissue” such as the Through Air Drying (TAD) manufacturing method, the manufacture of un-creped through-air dried (UCTAD) tissue, or alternative manufacturing methods, e.g. the Advanced Tissue Molding System (ATMOS) of the company Voith, or Energy Efficient Technologically Advanced Drying eTAD of the company Georgia Pacific, or Structured Tissue Technology SST of the company Metso Paper. Hybrid processes like NTT (New Textured Tissue of the company Metso Paper), which are alternations of the conventional processes, can be used.

According to some embodiments, the second ply is a structured paper ply, such as a ply made of TAD, UCTAD, eTAD, Atmos, or NTT.

According to some embodiments, the second ply has been embossed with a non-heated embossing roll. According to other embodiments, the second ply may not have been embossed in the sense of not having been pre-embossed prior to the prior ply bonding having been carried out.

Some embodiments of the tissue paper product comprise exactly two plies. In the following, these will be referred to as the first ply and the second ply.

The tissue paper product comprises two plies. In fact, a total number of plies of the tissue paper product is two. Put differently, the tissue paper product consists of two plies. However, the latter statement does not imply that the tissue paper product cannot comprise other constituents (other than plies), such as adhesive, additives, etc. It means only that the number of plies is two. At least one of the two plies is an embossed ply. However, both plies may be embossed plies.

The (heat-embossed) first ply comprises first embossments with a first height (h1). The first height (h1) is in a range of 0.2 mm to 2.0 mm.

The second ply may comprise second embossments with a second height (h2). The second height (h2) is in a range of 0.2 mm to 2.0 mm.

The adhesive, such as lamination glue, may have been applied to tips of the first embossments of the first ply and/or to tips of the second embossments of the second ply.

The first ply may comprise third embossments with a third height (h3) smaller than the first height (h1) (h1>h3).

The second ply may comprise fourth embossments with a fourth height (h4) smaller than the second height (h2) (h2>h4).

In other words, the top ply and/or the bottom ply may comprise two types of embossments and may have been processed using “double height embossing” whereby one or several rolls with embossing protrusions having different heights were used. Double height embossing may not only serve to provide bulk to the fibrous product but also to provide an improved optical appearance to the product. The optical appearance can be improved by combining embossing and coloring steps. Another reason for embossing is to generate higher absorbency or improved perceived softness. Analogous statements hold for embodiments of the tissue paper product comprising more than two plies.

Some embodiments of the tissue paper product comprise exactly three plies. These will in the following be referred to as the first ply and the second ply and a third ply, located between the first ply and the second ply.

The tissue paper product comprises three plies. In fact, a total number of plies of the tissue paper product is three. Put differently, the tissue paper product consists of three plies. However, the latter statement does not imply that the tissue paper product cannot comprise other constituents (other than plies), such as adhesive, additives, etc. It means only that the number of plies is three. At least one of the three plies is an embossed ply. One of the three, two of the three, or all three plies may be embossed plies.

The third ply may be made of Conventional Wet Press (CWP) paper.

The first ply may comprise first embossments with a first height (h1), the first height (h1) being in a range of 0.2 mm to 2.0 mm. The adhesive, such as lamination glue, may be applied to tips of the first embossments of the first ply.

The second ply may comprise second embossments with a second height (h2), the second height (h2) being in a range of 0.2 mm to 2.0 mm.

The first ply may comprise third embossments with a third height (h3) smaller than the first height h1 (h1>h3).

The second ply may comprise fourth embossments with a fourth height (h4) smaller than the second height h2 (h2>h4).

The adhesive, such as lamination glue, may have been applied to the third ply at parts bonded to tips of the first embossments of the first ply and/or to tips of the second embossments of the second ply, and/or the adhesive, such as lamination glue, may have been applied to tips of the first embossments of the first ply and/or to tips of the second embossments of the second ply.

According to some embodiments, the third ply has not been embossed prior to ply bonding. Sometimes, the third ply (the middle ply) may be referred to as an unembossed ply. With “unembossed”, it is meant that the third ply is not pre-embossed prior to the final ply-bonding being carried out. That is, the third ply may no longer be flat after the ply-bonding, but has not beforehand been embossed using an embossing roll.

According to some embodiments, the second ply and the third ply have been embossed together to form the second embossments on the second ply and the third ply.

According to some embodiments, the fourth embossments have been formed only on the second ply but not on the third ply. According to other embodiments, the second ply and the third ply have been embossed together to form the fourth embossments on the second ply and the third ply.

Some embodiments of the tissue paper product comprise exactly four plies. These will be referred to in the following as the first ply and the second ply, and a third ply and a fourth ply. The third ply and the fourth ply are located between the first ply and the second ply. The third ply may be made of Conventional Wet Press (CWP) paper, and/or the fourth ply may be made of Conventional Wet Press (CWP) paper.

The tissue paper product comprises four plies. In fact, a total number of plies of the tissue paper product is four. Put differently, the tissue paper product consists of four plies. However, the latter statement does not imply that the tissue paper product cannot comprise other constituents (other than plies), such as adhesive, additives, etc. It means only that the number of plies is four. At least one of the four plies is an embossed ply. One of the four may be an embossed ply, or two of the four, three of the four, or all four plies may be embossed plies.

The first ply may comprise first embossments with a first height (h1), the first height (h1) being in a range of 0.2 mm to 2.0 mm.

The second ply may comprise second embossments with a second height (h2), the second height (h2) being in a range of 0.2 mm to 2.0 mm.

The first ply may comprise third embossments with a third height (h3) smaller than the first height h1 (h1>h3).

The second ply may comprise fourth embossments with a fourth height (h4) smaller than the second height h2 (h2>h4).

According to some embodiments, the first ply may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm2 or less, optionally 10 dots/cm2 or less.

According to some embodiments, the second ply may include one or two types of embossments, being decorative embossments with an embossing height in a range of 0.2 mm to 2.0 mm, optionally 0.8 mm to 1.4 mm, and/or micro-embossments with an embossing height in a range of 0.1 mm to 1.2 mm. The decorative embossments may be provided with a density of 15 dots/cm² or less, optionally 10 dots/cm² or less.

Micro-embossments and/or decorative embossments may be in the form of lines or dots or other shapes. In the case that the decorative embossments are dot-shaped, the density may be lower than 10 embossments/cm² for the decorative embossments.

The adhesive, such as lamination glue, may have been applied to the third ply and/or the fourth ply at parts bonded to tips of the first embossments of the first ply and/or to tips of the second embossments of the second ply, and/or the adhesive, such as lamination glue, may have been applied to tips of the first embossments of the first ply and/or to tips of the second embossments of the second ply.

The second ply and the fourth ply may have been embossed together to form the second embossments on the second ply and the fourth ply.

According to some embodiments, the third ply has not been embossed prior to ply-bonding or has been embossed separately from the first ply, the second ply, and the fourth ply.

According to some embodiments, the third embossments are formed only on the second ply but not on the fourth ply. According to other embodiments, the second ply and the fourth ply have been embossed together to form the third embossments on the second ply and the fourth ply.

According to some embodiments, the second ply, the third ply, and the fourth ply have been embossed together to form the first embossments on the second ply, the third ply, and the fourth ply.

According to some embodiments, the second ply, the third ply, and the fourth ply have been embossed together to form the fourth embossments on the second ply, the third ply, and the fourth ply.

According to some embodiments, the fourth embossments have been formed on the second ply and the fourth ply, but not on the third ply.

According to some embodiments, the fourth embossments have been formed on the second ply, but not on the third ply and the fourth ply.

According to some embodiments, the third ply and the fourth ply have been embossed together separately from the first ply and the second ply. According to other embodiments, one of the third ply and the fourth ply has been separately embossed from the first ply and the second ply, and the other one of the third ply and the fourth ply is unembossed. According to yet other embodiments, the third ply and the fourth ply are unembossed. With “unembossed”, reference is made to a ply that was not pre-embossed prior to the final ply-bonding.

In accordance with any one of the above-described embodiments, the first embossments may be provided on an area constituting between 1% and 20% of a total surface of the first ply, and/or a density of the third embossments may be in a range of 25 to 120 embossments/cm², optionally 40 to 100 embossments/cm², or 50 to 80 embossments/cm².

The grammage of each of the plies of any one of the above-described embodiments the tissue paper products may be in a range of 13 to 30 g/m², optionally 16 to 28 g/m², or 18 to 24 g/m².

One aspect of this disclosure relates to a tissue paper product, such as toilet paper or household towel, wherein the tissue paper product comprises between two and four plies, including at least a first ply and a second ply, the two plies, three plies, or four plies being ply-bonded, optionally using an adhesive such as lamination glue or mechanical bonding, such as edge embossing, to form the tissue paper product, the first ply and the second ply being the outermost plies of the tissue paper product.

A grammage of each of the plies being in a range of 13 to 30 g/m², optionally 16 to 28 g/m², or 18 to 24 g/m². The first ply is a structured paper ply, such as a ply made of TAD, UCTAD, eTAD, Atmos, or NTT, and the first ply has been embossed with a heated embossing roll.

The embossing of the first ply with a heated embossing roll may be advantageous as the embossments may have a better shape memory, i.e., they may be more resilient against shape deformation when the tissue paper product is wet. That is, the embossments being less affected when the ply is wet. This means that the tissue paper product may have a better absorption capacity than a comparable tissue paper product which does not comprise at least one ply that was embossed using a heated embossing roll. Moreover, as compared to a product without a ply that was embossed using a heated embossing roll with a certain thickness and strength (tensile strength), a higher thickness may be reached while retaining the same tensile strength. In other words, the tissue paper product in accordance with the present disclosure has high thickness and good absorption properties, as well as a high tensile strength. In particular, with the same embossing load (as used for manufacturing a comparative product under the same conditions with the exception embossing without a heated embossing roll) during a manufacturing process, a higher thickness of the tissue product may be reached.

The tissue paper products in accordance with the present disclosure, and in particular, embodiments with a heat-embossed structured paper ply and a CWP ply as outermost plies, may have similarly high thicknesses as comparative products comprising two outer plies being structured paper plies manufactured without heat-embossing, but they may be cheaper to manufacture.

Another aspect of this disclosure relates to a roll of tissue paper product made of a spirally wound continuous web of the tissue paper product of any one of the above-described embodiments.

The tissue paper product has a first end and a second end. The web of tissue paper product is wound such as to define an axially extending inner hole centrally positioned relative to the roll and such that the first end is located on the outer side of the roll and the second end is located at the inner hole.

According to some embodiments, the tissue paper product of the roll is provided with perforations for tearing off individual sheets.

A diameter of the roll may be in a range of 85 to 200 mm (including the boundaries). Such a roll is particularly suitable for household towels.

This disclosure also relates to a stack of unfolded sheets or a stack of folded sheets of the tissue paper product in accordance with any one or several of the above-described embodiments. In the case of some embodiments, the folded sheets may be separate individual folded sheets, or individual separate interfolded sheets. Alternatively, continuous sheets (with or without perforations for separating sheets) may be folded to form the stack. Optionally, the folded sheets may be multi-interfolded.

This disclosure also relates to a method of manufacturing a tissue paper product, such as toilet paper or household towel, comprising at least two plies. The method may be used to manufacture a tissue paper product in accordance with any one or several of the above-described embodiments of tissue paper product. Every one of the features of an embodiment of the tissue paper product translates into a feature of an embodiment of the method, and vice versa. These statements equally apply to embodiments of the method in accordance with the present disclosure for manufacturing tissue paper products comprising two plies, three plies, or four plies.

The method comprises the steps of:
feeding between two and four plies, including at least a first ply being a structured paper ply, such as a ply made of TAD, UCTAD, eTAD, Atmos, or NTT, and a second ply, with each ply having a grammage in a range of 13 to 30 g/m², optionally 16 to 28 g/m², or 18 to 24 g/m²;
embossing the first ply on a first embossing roll with first embossing protrusions with a first height (h1) to form first embossments on the first ply,
embossing the second ply on a second embossing roll with second embossing protrusions with a second height (h2) to form second embossments on the second ply,
ply-bonding the two plies, three plies, or four plies ply, optionally using an adhesive, such as a lamination glue, or mechanical bonding, such as edge embossing, to form the tissue paper product.

The step of embossing the first ply is performed using a heated first embossing roll.

With “edge embossing”, reference is made to a technique of mechanically bonding plies on the edges. This may be done with wheels with lines of side embossing and a flat counter-cylinder, and the ply-bonding is effected by exerting mechanical pressure.

Each of the embossing rolls used for manufacturing the tissue paper product may be a roll comprising a hard material such as metal, especially steel. Alternatives comprise embossing rolls made of hard rubber or hard plastics materials. The embossing rolls can be a male roll having individual protrusions. Typical heights/depths of the engraved embossing patterns are between 0.2 and 2.0 mm. For the heated embossing, a heatable embossing roll is used.

The machinery used for performing the method may comprise an application system for adhesive consisting of applicator roll, adhesive transfer roll and adhesive bath can be designed as a so-called immersion roll system in which the adhesive transfer roll is partially immersed into the adhesive bath and transports adhesive by means of surface tension and adhesive forces out of the adhesive bath. By adjusting the gap between the adhesive transfer roll and the applicator or application roll, or by adjusting the relative speed of the transfer roll relative to the applicator roll, the amount of adhesive to be applied can be adjusted. Application rolls may be structured rolls. According to some embodiments, the adhesive may be partially or fully replaced by water. In other words, some or all of the ply-bonding may be carried out using water. A bonding pressure applied to plies to be ply-bonded using water may be set higher than for embodiments in which plies are ply-bonding using an adhesive such as lamination glue.

The at least one heatable roll may be heatable from the inside or outside by a heating means.

The heating means may comprise heat carrying fluid and/or rely on induction and/or infrared heating.

The heatable roll may be heatable to a surface temperature in the range of 80° C. to 170°, optionally 100° C. to 165°, 110° C. to 165°, 120° C. to 160°, or 130° C. to 155°. These temperature ranges may to an increasing degree with narrower ranges promote the manufacturing of a tissue paper product with good shape memory and/or large thickness, high machine direction (MD) and/or cross direction (CD) tensile strength, and good absorption properties.

The references to the temperatures of the heatable embossing roll(s) in this text are references, in particular, to surface temperatures of the embossing roll. These may be measured, for example, using an infrared thermometer. Moreover, the temperature values refer to temperatures in the steady state of the manufacturing apparatus, i.e., not while running and while plies are in contact with the embossing rolls. In particular, the surface temperature of the heatable embossing roll may drop during manufacturing, due to various effects such as heat conduction to the ply in contact with the roll, etc. For example, a surface temperature of 170° C. might be measured in the steady state (when the embossing roll is not in contact with a ply), and this temperature might decrease to a temperature in the range of 100° C. to 130° C. during manufacturing, etc.

The indicated temperature ranges may, to an increasing degree with increasingly narrower ranges, promote being able to produce tissue paper products with an increased (cross-and/or main direction) tensile strength as compared to reference products which are made the same way but without using heated embossing rolls. The strength increase may be in a range of about 5-25% or even 20-25%. In addition or alternative thereto, a gain in absorption capacity of about 15% and/or an increase in cross-directional (CD) tensile strength of about 5-10% may be achieved, while (for each case) the softness of the product may not be decreased or only insignificantly decreased with respect to the respective reference product.

A moisture content of a mother reel used to supply plies for manufacturing tissue paper products in accordance with the present disclosure may be in a range of 3% to 15%, optionally 3% to 10%, or optionally 4% to 7%.

The first ply may be moistened with a liquid, such as water with or without one or several additives. The first ply may be moistened with an amount of liquid in the range of 2% to 12% of the basis weight of the first ply, or optionally 4% to 10% of the basis weight of the first ply, prior to being embossed with a heated embossing roll. Analogous statements hold with respect to the second ply.

To moisten the first ply, a manufacturing apparatus may include a wetting unit that is configured to provide a liquid, such as water or, for example, water provided with one or several additives such as softening agents and/or vitamins and/or scents, to the first ply. According to some embodiments, the wetting unit is configured to spray the liquid onto the respective ply. The wetting in these ranges may, to an increasing degree with increasingly narrower ranges, promote high tensile strength, good softness properties, and absorption capacity in the manufactured tissue paper products.

According to some embodiments, the apparatus does not comprise a wetting unit for providing a liquid to any of the plies. In other words, the apparatus may be configured to process the first ply without wetting it with a liquid. Such embodiments may promote high tensile strength, good softness properties, and absorption capacity in the manufactured products.

According to some embodiments, the first ply is, hence, not moistened with a liquid prior to the step of embossing the first ply. The first ply may in these cases be referred to as a dry heat-embossed ply.

The second ply may be made of Conventional Wet Press (CWP) paper or may be structured paper ply, such as a ply made of TAD, UCTAD, eTAD, Atmos, or NTT. According to some embodiments, the method comprises a step of embossing the second ply using a non-heated second embossing roll. According to other embodiments, the method comprises a step of embossing the second ply using a heated second embossing roll.

Some embodiments of the method manufacture a tissue paper product comprising exactly two plies and having a grammage in a range of 24 to 50 g/m². These embodiments may comprise the steps of:
embossing the first ply with the heated first embossing roll with the first embossing protrusions to form the first embossments with a first height (h1) in a range of 0.2 mm to 2.0 mm; and
embossing the second ply with the second embossing roll with the second embossing protrusions to form the second embossments with a second height (h2) in a range of 0.2 mm to 2.0 mm.

According to some embodiments, the first embossing roll also comprises third embossing protrusions, and the step of embossing the first ply forms first and third embossments on the first ply. According to other embodiments, the method comprises a step of embossing the first ply with a third embossing roll with third embossing protrusions to form third embossments. In other words, a second type of embossments may be formed on the first ply either with one and the same embossment roll as used for the first embossments, or they may be formed with another embossing roll.

Analogous statements hold for yet further types of embossments (different types referring to embossments with different shapes and/or different embossment heights, etc.).

The third embossments may have a third height (h3) smaller than the first height h1 (h1>h3).

According to some embodiments, the second embossing roll also comprises fourth embossing protrusions, and the step of embossing the second ply forms second and fourth embossments on the third ply. According to other embodiments, the method comprises a step of embossing the second ply with a fourth embossing roll with fourth embossing protrusions to form fourth embossments. In other words, a second type of embossments may be formed on the second ply either with one and the same embossment roll as used for the second embossments, or they may be formed with another embossing roll.

Analogous statements hold for yet further types of embossments (different types referring to embossments with different shapes and/or different embossment heights, etc.).

The height of the fourth embossments h4 may be smaller than the height of the second embossments h2 (h2>h4).

Some embodiments of the method manufacture a tissue paper product comprising exactly three plies and having a grammage in a range of 34 to 65 g/m². The three plies will in the following be referred to as the first ply, the second ply, and a third ply, located between the first ply and the second ply.

Embodiments of the method comprise the steps of:
embossing the first ply with the heated first embossing roll with the first embossing protrusions to form the first embossments with a first height (h1) in a range of 0.2 mm to 2.0 mm; and
embossing the second ply with the second embossing roll with the second embossing protrusions to form the second embossments with a second height (h2) in a range of 0.2 mm to 2.0 mm.

According to some embodiments, the first embossing roll also comprises third embossing protrusions, and the step of embossing the first ply forms first and third embossments on the first ply. According to other embodiments, the method comprises a step of embossing the first ply with a third embossing roll with third embossing protrusions to form third embossments. In other words, a second type of embossments may be formed on the first ply either with one and the same embossment roll as used for the first embossments, or they may be formed with another embossing roll.

Analogous statements hold for yet further types of embossments (different types referring to embossments with different shapes and/or different embossment heights, etc.).

The third embossments may have a third height (h3) smaller than the first height h1 (h1>h3).

According to some embodiments, the second embossing roll also comprises fourth embossing protrusions, and the step of embossing the second ply forms second and fourth embossments on the third ply. According to other embodiments, the method comprises a step of embossing the second ply with a fourth embossing roll with fourth embossing protrusions to form fourth embossments. In other words, a second type of embossments may be formed on the second ply either with one and the same embossment roll as used for the second embossments, or they may be formed with another embossing roll.

Analogous statements hold for yet further types of embossments (different types referring to embossments with different shapes and/or different embossment heights, etc.).

The height of the fourth embossments h4 may be smaller than the height of the second embossments h2 (h2>h4).

Some embodiments of the method do not comprise a step of embossing the third ply. In other words, according to these embodiments, the third ply is not pre-embossed prior to the step of final ply-bonding of all three plies.

According to some embodiments, the method comprises a step of embossing the first ply and the third ply together to form the first embossments on the first ply and the third ply.

The first ply and the third ply may be embossed together to form also the third embossments on the first ply and the third ply.

Some embodiments of the method manufacture a tissue paper product comprising exactly four plies and having a grammage in a range of 55 to 95 g/m². The four plies will in the following be referred to as the first ply, the second ply, as well as a third ply and a fourth ply, the third ply and the fourth ply being located between the first ply and the second ply.

The third ply may be made of Conventional Wet Press (CWP) paper.

The fourth ply may be made of made of Conventional Wet Press (CWP) paper.

According to some embodiments, the method comprises the steps of:
embossing the first ply with the heated first embossing roll with the first embossing protrusions to form the first embossments with a first height (h1) in a range of 0.2 mm to 2.0 mm;
embossing the second ply with the second embossing roll with the second embossing protrusions to form the second embossments with a second height (h2) in a range of 0.2 mm to 2.0 mm.

The first embossing roll may also comprise third embossing protrusions, and the step of embossing the first ply forms the first and third embossments on the first ply, the third embossments having a third height (h3) smaller than the first height (h1) (h1>h3).

Some embodiments of the method comprise a step of embossing the first ply with a third embossing roll with third embossing protrusions to form third embossments on the first ply, the third embossments having a third height (h3) smaller than the first height (h1) (h1>h3). Analogous statements hold for yet further types of embossments (different types referring to embossments with different shapes and/or different embossment heights, etc.).

According to some embodiments, the second embossing roll also comprises fourth embossing protrusions, and the step of embossing the second ply forms second and fourth embossments on the second ply. According to other embodiments, the method comprises a step of embossing the second ply with a fourth embossing roll with fourth embossing protrusions to form fourth embossments. In other words, a second type of embossments may be formed on the second ply either with one and the same embossment roll as used for the second embossments, or they may be formed with another embossing roll. Analogous statements hold for yet further types of embossments (different types referring to embossments with different shapes and/or different embossment heights, etc.).

Embodiments of the method may comprise the step of embossing the second ply and the fourth ply together to form the second embossments on the second ply and the fourth ply.

The method may not comprise a step of embossing the third ply. In other words, the third ply may not be pre-embossed prior to the final ply-bonding being carried out. According to other embodiments, the third ply is embossed separately from the first ply, the second ply, and the fourth ply.

According to some embodiments, the fourth embossments are formed only on the second ply but not on the fourth ply. According to other embodiments, the second ply and the fourth ply are embossed together to form the fourth embossments on the second ply and the fourth ply.

The second ply, the third ply, and the fourth ply may be embossed together to form the second embossments on the second ply, the third ply, and the fourth ply.

The second ply, the third ply, and the fourth ply may be embossed together to form the fourth embossments on the second ply, the third ply, and the fourth ply. Alternatively, the fourth embossments may be formed on the second ply and the fourth ply, but not on the third ply. Yet alternatively, the fourth embossments may be formed on the second ply, but not on the third ply and the fourth ply.

According to some embodiments, the third ply and the fourth ply are embossed together separately from the first ply and the second ply.

The method may not comprise a step of (pre-)embossing the third ply.

The method may not comprise a step of (pre-)embossing the fourth ply.

According to some embodiments, the first embossments are formed on an area of the first ply constituting between 1% and 20% of a total surface of the first ply, and/or the third embossments are formed with a density in a range of 25 to 120 embossments/cm², optionally 40 to 100 embossments/cm², or 50 to 80 embossments/cm².

An embossing load during the embossing of the first ply may be in a range of from to 1 to 50 kg/cml, or optionally 5 to 40 kg/cml.

According to some embodiments, the second embossments are formed on an area of the second ply constituting between 1% and 20% of a total surface of the second ply, and/or the fourth embossments are formed with a density in a range of 25 to 120 embossments/cm², optionally 40 to 100 embossments/cm², or 50 to 80 embossments/cm².

An embossing load during the embossing of the second ply may be in a range of from to 1 to 50 kg/cml, or optionally 5 to 40 kg/cml.

This disclosure further relates to a tissue paper product manufactured according to any of the above-mentioned embodiments of the method in accordance with the present disclosure. Such a tissue paper product may have a good shape memory in terms of the resilience of the embossments after having been wet. The statements about shape memory for the respective embodiments of the tissue paper product are equally applicable to the tissue paper product manufactured in accordance with the method of the present disclosure.

This disclosure also relates to a roll of a tissue paper product, such as toilet paper or household towel, made of a spirally wound continuous web of the tissue paper product having a first end and a second end, the web of the tissue paper product being wound such as to define an axially extending inner hole centrally positioned relative to the roll and such that the first end is located on the outer side of the roll and the second end is located at the inner hole, the tissue paper product being the tissue paper product manufactured in accordance with an embodiment of the method in accordance with the present disclosure.

This disclosure also relates to a stack of unfolded sheets or of folded sheets of tissue paper product manufactured in accordance with an embodiment of the method in accordance with the present disclosure.

Additional advantages and features of the present disclosure, that can be realized on their own or in combination with one or several features discussed above, insofar as the features do not contradict each other, will become apparent from the following description of particular embodiments.

### BRIEF DESCRIPTION OF THE DRAWINGS

For a better understanding of the present disclosure and to show how the same may be carried into effect, reference will now be made, by way of example only, to the accompanying drawings, in which:

The description is given with reference to the accompanying drawings, in which:

FIGS. 1 to 7 are sectional views of embodiments of a tissue paper product in accordance with the present disclosure, each of which comprises two plies;

FIGS. 8 to 18 are sectional views of embodiments of a tissue paper product in accordance with the present disclosure, each of which comprises three plies; and

FIG. 19 depicts a manufacturing apparatus with which embodiments of the method of manufacturing a tissue paper product in accordance with the present disclosure is carried out.

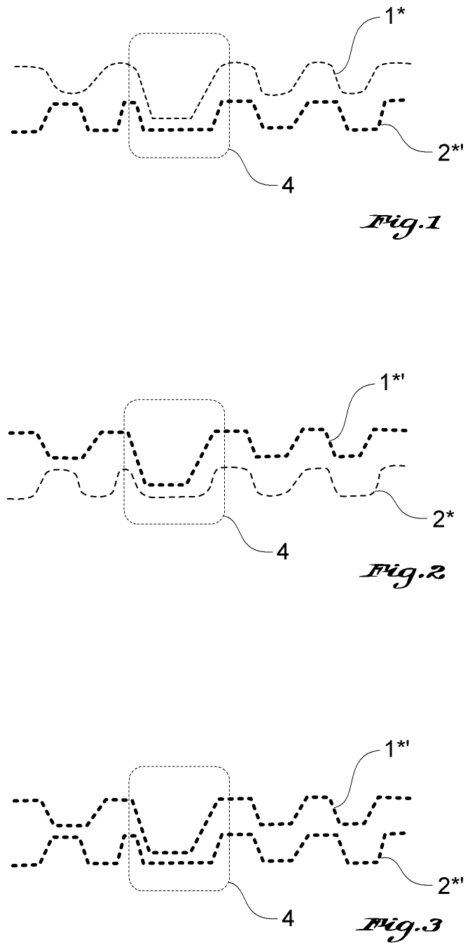

The embodiments of a tissue paper product of FIGS. 1 to 7 comprise two plies: a top ply 1, 1′ 1*, 1*′ and a bottom ply 2, 2′, 2*, 2*′. Regarding the nomenclature: The apostrophe indicates that the ply has been heat-embossed. The asterisk indicates that the ply is a structured paper ply. For example: “1” stands for a CWP top ply that was not heat-embossed. “1′” stands for a heat-embossed CWP top ply. “1*” stands for a structured paper top ply that was not heat-embossed. “1*′” stands for a heat-embossed structured paper top ply. This nomenclature is used throughout the descriptions accompanying FIGS. 1 to 15. Moreover, a heat-embossed ply is illustrated with a slightly thicker lines in the figures than a non-heat embossed counter-part. A structured ply is illustrated using a dashed line, whereas a CWP ply is illustrated using a regular line.

In the case of all of the embodiments of FIGS. 1 to 7, the top ply has been double-height embossed, i.e., it comprises two types of embossments with different heights. The bottom ply has been all cases been embossed with one type of embossments. The embossing is here referred to as a pre-embossing, i.e., an embossing prior to the final bonding having been carried out.

In the case of all embodiments of FIGS. 1 to 7, the top ply and the bottom ply have been ply-bonded. An example of where the respective plies are ply-bonded is shown as the respective region 4. The two plies have been ply-bonded using an adhesive (lamination glue). However, according to other embodiments, the ply-bonding could, e.g., have been effected using mechanical bonding such as edge embossing.

The top ply 1* of FIG. 1 is a structured paper ply made of TAD, UCTAD, eTAD, Atmos, or NTT. The top ply 1* has been embossed with a non-heated embossing roll.

The bottom ply 2*′ of FIG. 1 is a structured paper ply made of TAD, UCTAD, eTAD, Atmos, or NTT and has been embossed with a heated embossing roll. It is thus an example of a “first ply” in the sense of the present application. In other words, the first ply is in the case of the embodiment of FIG. 1 the bottom ply. The top ply of

FIG. 1 is a “second ply” in the sense of the present application. The bottom ply 2*′ has been embossed with a heated first embossing roll heated to a temperature in the range of 80° C. to 170°. It is illustrated with a thickened line, in order to illustrate that it has been heat-embossed.

The embodiment of FIG. 2 differs from the one of FIG. 1 in that the top ply 1*′ of FIG. 2 is a structured paper ply made of TAD, UCTAD, eTAD, Atmos, or NTT that has been heat-embossed using a heated embossing roll, i.e., with a heated first embossing roll heated to a temperature in the range of 80° C. to 170°. It is illustrated with a thickened line, in order to illustrate that it has been heat-embossed. The bottom ply 2* of FIG. 2 is also a structured paper ply made of TAD, UCTAD, eTAD, Atmos, or NTT. However, the bottom ply 2* has been embossed with a non-heated embossing roll.

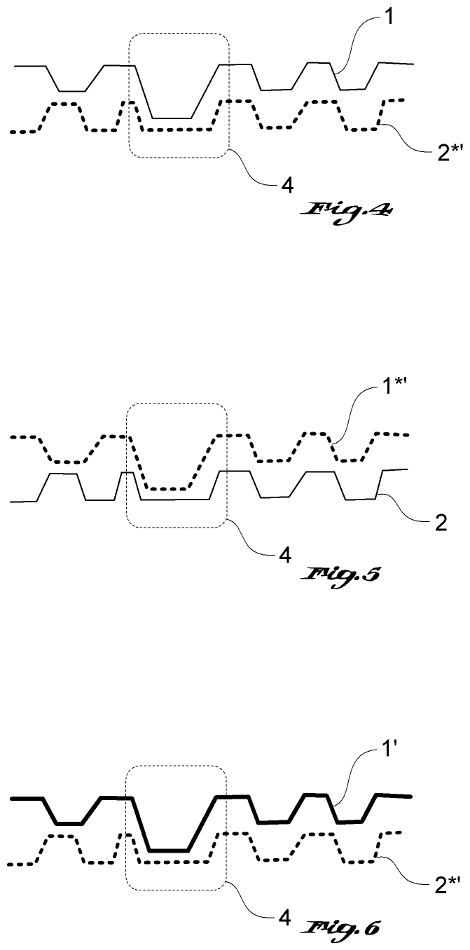

The embodiment of FIG. 3 comprises both a top ply 1*′ that is a structured paper ply made of TAD, UCTAD, eTAD, Atmos, or NTT which has been heat-embossed using a heated embossing roll, i.e., with a heated first embossing roll heated to a temperature in the range of 80° C. to 170°, as well as a bottom ply 2*′ that is a structured paper ply made of TAD, UCTAD, eTAD, Atmos, or NTT which has been heat-embossed using a heated embossing roll, i.e., with a heated second embossing roll heated to a temperature in the range of 80° C. to 170°.

Whereas the embodiments of FIGS. 1 to 3 comprise both a structured paper ply as a top ply as well as a structured paper ply as a bottom ply, the embodiments of FIGS. 4 to 7 comprise a structured ply as well as a CWP ply.

The embodiment of FIG. 4 comprises a top ply 1 that is made of Conventional Wet Press (CWP) paper which has been embossed using a non-heated embossing roll. It further comprises a bottom ply 2*′ that is a structured paper ply made of TAD, UCTAD, eTAD, Atmos, or NTT which has been heat-embossed using a heated embossing roll, i.e., with a heated embossing roll heated to a temperature in the range of 80° C. to 170°.

The embodiment of FIG. 5 comprises a top ply 1*′ that is a structured paper ply made of TAD, UCTAD, eTAD, Atmos, or NTT which has been heat-embossed using a heated embossing roll, i.e., with a heated first embossing roll heated to a temperature in the range of 80° C. to 170°. It further comprises a bottom ply 2*′ made of Conventional Wet Press (CWP) paper which has been embossed using a non-heated embossing roll.

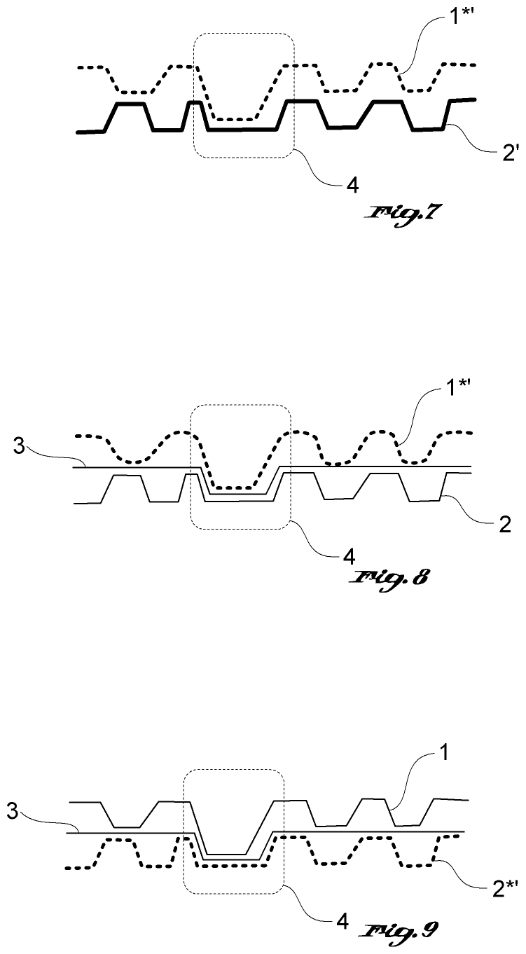

The embodiment of FIG. 6 comprises a top ply 1′ that is made of Conventional Wet Press (CWP) paper which has been heat-embossed using a heated embossing roll, i.e., with a heated embossing roll heated to a temperature in the range of 80° C. to 170°. It further comprises a bottom ply 2*′ that is a structured paper ply made of TAD, UCTAD, eTAD, Atmos, or NTT which has been heat-embossed using a heated embossing roll, i.e., with a heated first embossing roll heated to a temperature in the range of 80° C. to 170°.

The embodiment of FIG. 5 comprises a top ply 1*′ that is a structured paper ply made of TAD, UCTAD, eTAD, Atmos, or NTT which has been heat-embossed using a heated first embossing roll, i.e., with a heated embossing roll heated to a temperature in the range of 80° C. to 170°. It further comprises a bottom ply 2*′ made of Conventional Wet Press (CWP) paper which has been heat-embossed using a heated embossing roll, i.e., with a heated embossing roll heated to a temperature in the range of 80° C. to 170°.

A grammage of the tissue paper products of FIGS. 1 to 7 is in a range of 24 to 50 g/m², respectively.

The embodiments of FIGS. 8 to 15 are embodiments comprising exactly three plies.

The top ply 1* of the embodiment of FIG. 3 is a structured paper ply made of TAD, UCTAD, eTAD, Atmos, or NTT. It was embossed using a heated first embossing roll, i.e., an embossing roll heated to a (steady-state) temperature in the range of 80° C. to 170°. The middle ply 3 of FIG. 8 is a ply made of Conventional Wet Press (CWP) paper and it was not pre-embossed (prior to the final ply-bonding). The bottom ply 2 of the embodiment of FIG. 8 is a ply made of Conventional Wet Press (CWP) paper. It was embossed using a non-heated embossing roll.

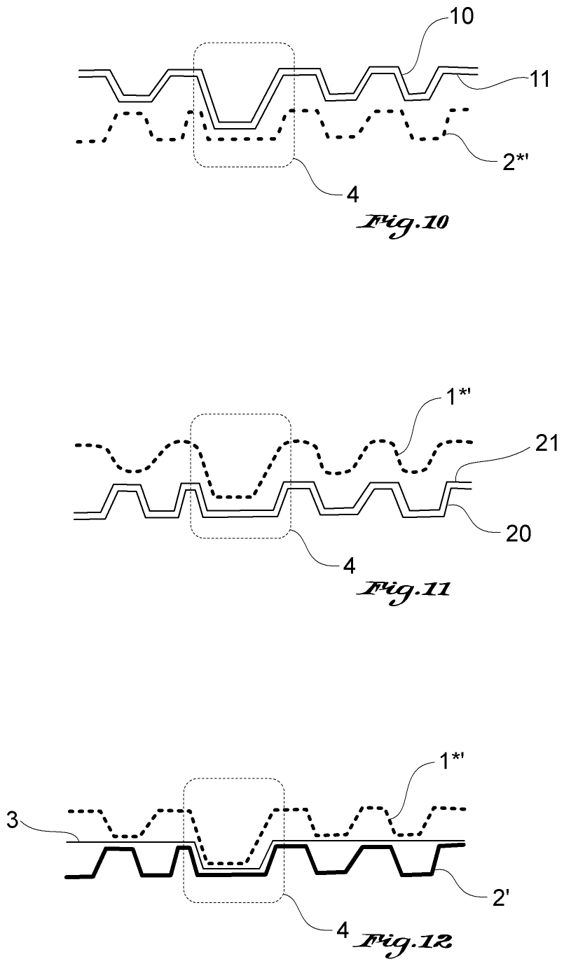

The top ply 1 of the embodiment of FIG. 9 is a ply made of Conventional Wet Press (CWP) paper. It was embossed using a non-heated embossing roll. The middle ply 3 of FIG. 9 is another ply made of Conventional Wet Press (CWP) paper and it was not pre-embossed (prior to the final ply-bonding). The bottom ply 2*′ of the embodiment of FIG. 9 is a structured paper ply made of TAD, UCTAD, eTAD, Atmos, or NTT. It was heat-embossed using a heated embossing roll, i.e., an embossing roll heated to a (steady-state) temperature in the range of 80° C. to 170°.

In the case of the embodiment of FIG. 10, the top ply 10 and the neighboring ply 11 are both made of Conventional Wet Press (CWP) paper and have been double-height embossed together using a non-heated embossing roll. The bottom ply 2*′ of FIG. 10 is a structured paper ply made of TAD, UCTAD, eTAD, Atmos, or NTT. It was embossed using a heated embossing roll, i.e., an embossing roll heated to a (steady-state) temperature in the range of 80° C. to 170°.

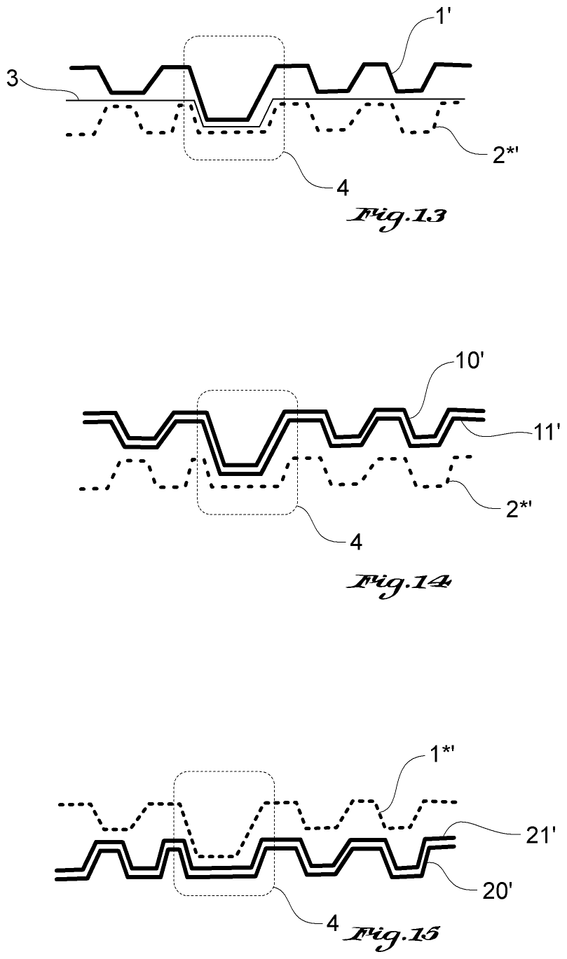

In the case of the embodiment of FIG. 11, the top ply 1*′ is a structured paper ply made of TAD, UCTAD, eTAD, Atmos, or NTT, that was embossed using a heated embossing roll, i.e., an embossing roll heated to a (steady-state) temperature in the range of 80° C. to 170°. The bottom ply 20 and the neighboring ply 21 are both made of Conventional Wet Press (CWP) paper and have been double-height embossed together using a non-heated embossing roll.

The embodiment of FIG. 12 comprises a top ply 1*′ that is a structured paper ply made of TAD, UCTAD, eTAD, Atmos, or NTT, that was embossed using a heated embossing roll, i.e., an embossing roll heated to a (steady-state) temperature in the range of 80° C. to 170°. The middle ply 3 of FIG. 12 is another ply made of Conventional Wet Press (CWP) paper and it was not pre-embossed (prior to the final ply-bonding). The bottom ply 2′ of the embodiment of FIG. 12 is made of Conventional Wet Press (CWP) paper and has been heat-embossed using a heated embossing roll, i.e., an embossing roll heated to a (steady-state) temperature in the range of 80° C. to 170°.

The embodiment of FIG. 13 comprises a top ply 1′ made of Conventional Wet Press (CWP) paper and has been heat-embossed using a heated embossing roll, i.e., an embossing roll heated to a (steady-state) temperature in the range of 80° C. to 170°. The middle ply 3 of FIG. 12 is another ply made of Conventional Wet Press (CWP) paper and it was not pre-embossed (prior to the final ply-bonding). The bottom ply 2*′ of the embodiment of FIG. 12 is a structured paper ply made of TAD, UCTAD, eTAD, Atmos, or NTT, that was embossed using a heated embossing roll, i.e., an embossing roll heated to a (steady-state) temperature in the range of 80° C. to 170°.

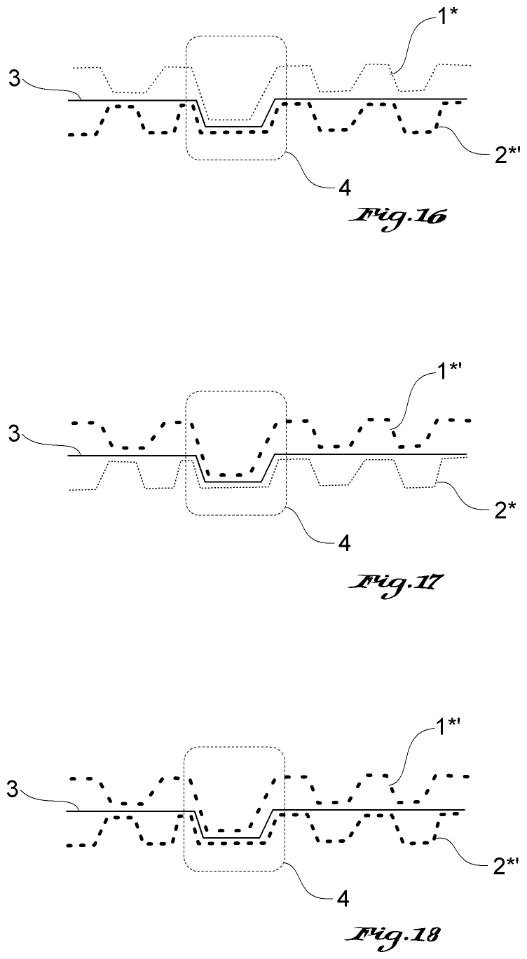

In the case of the embodiment of FIG. 14, the top ply 10′ and the neighboring ply 11′ are both made of Conventional Wet Press (CWP) paper and have been double-height heat-embossed together using a heated embossing roll, i.e., an embossing roll heated to a (steady-state) temperature in the range of 80° C. to 170°.The bottom ply 2*′ of FIG. 10 is a structured paper ply made of TAD, UCTAD, eTAD, Atmos, or NTT. It was embossed using a heated embossing roll, i.e., an embossing roll heated to a (steady-state) temperature in the range of 80° C. to 170°.

In the case of the embodiment of FIG. 15, the top ply 1*′ is a structured paper ply made of TAD, UCTAD, eTAD, Atmos, or NTT, that was embossed using a heated embossing roll, i.e., an embossing roll heated to a (steady-state) temperature in the range of 80° C. to 170°. The bottom ply 20′ and the neighboring ply 21′ are both made of Conventional Wet Press (CWP) paper and have been double-height heat-embossed together using a heated embossing roll, i.e., an embossing roll heated to a (steady-state) temperature in the range of 80° C. to 170°.

FIGS. 16 to 18 depict embodiments with a middle ply 3 made of CWP, a top ply 1*, 1*′ being a structured paper ply made of TAD, UCTAD, eTAD, Atmos, or NTT, and a bottom ply 2*, 2*′ being a structured paper ply made of TAD, UCTAD, eTAD, Atmos, or NTT.

In the case of the embodiment of FIG. 16, the top ply 1* was embossed using a non-heated embossing roll, whereas the bottom ply 2*′ was heat-embossed using a heated embossing roll, i.e., an embossing roll heated to a (steady-state) temperature in the range of 80° C. to 170°.

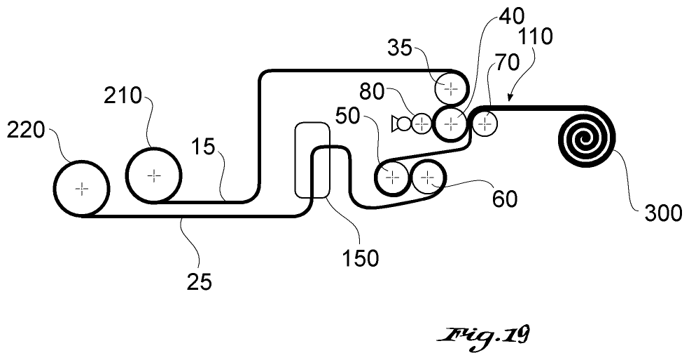

In the case of the embodiment of FIG. 17, the top ply 1*′ was heat-embossed using a heated embossing roll, i.e., an embossing roll heated to a (steady-state) temperature in the range of 80° C. to 170°, whereas the bottom ply 2* was embossed using a non-heated embossing roll.

Moreover, the embodiment of FIG. 18 comprises a top ply 1*′ that was heat-embossed using a heated embossing roll, i.e., an embossing roll heated to a (steady-state) temperature in the range of 80° C. to 170°, as well as a bottom ply 2*′ that was heat-embossed using a heated embossing roll, i.e., an embossing roll heated to a (steady-state) temperature in the range of 80° C. to 170°.

The grammage of the tissue paper products of FIGS. 8 to 18 is in a range of 34 to 65 g/m².

FIG. 19 is a schematic representation of (a part of) and embodiment of a manufacturing apparatus for manufacturing a tissue paper product in accordance with the present disclosure using an embodiment of a method in accordance with the present disclosure. In the following, it will be described how an embodiment of the method is carried out using the apparatus illustrated in FIG. 19.

A first ply 15 made of Conventional Wet Press (CWP) paper is provided. It is unwound from a first unwinding roll 210. A second ply 25, being a structured paper ply made of TAD, UCTAD, eTAD, Atmos, or NTT, is provided. It is unwound from a second unwinding roll 220.

The structured paper ply 25 is moistened in a wetting unit 150 with water and then heat-embossed between an embossing roll 50 and a counter roll 60. The heatable embossing roll 50 is heated to a steady-state temperature in the range of 80° C. to 170° C.

The CWP paper ply 15 is embossed between a non-heatable embossing roll 40 and a counter roll 35. It is also provided with adhesive using a transfer roll 80.

The CWP ply 15 and the heat-embossed structured paper ply 25 are then ply-bonded between the embossing roll 40 and a marrying roll 70. The two-ply tissue paper product 110 is then wound-up on the winding roll 300.

Each of the tissue paper products of FIGS. 1 to 18 as well as the ones manufactured using the apparatus of FIG. 19 have a high absorption capacity, a large thickness (as compared to conventional products with a similar strength), and a high (tensile) strength (as compared to conventional products with a similar thickness). Specifically, the tissue paper products have a good wetness shape memory, i.e., the embossments disappear less than in comparable conventional products when the product has been wet.

### EXPERIMENTAL RESULTS

In the following, experimental examples of embodiments (examples) in accordance with the present disclosure will be compared with conventional tissue paper products.

In order to evaluate the performance of tissue paper products in accordance with the present disclosure (manufactured in accordance with the method in accordance with the present disclosure), several reference products were manufactured. The reference products were manufactured without using any heat-embossing, i.e., without embossing a ply using a heated embossing roll.

### Reference Products A

To acquire first reference measurements (“reference products A”), two structured TAD plies with a grammage of about 20 g/m² were investigated.

### Reference Product B

A reference product B was manufactured with two structured TAD plies. Both structured paper plies made of TAD were provided with a grammage of about 20 g/m². The top ply was embossed with a single height embossing design. The bottom ply was not pre-embossed, but instead conveyed to the main embossing station, where the top ply and the bottom ply were ply-bonded together using glue at tips of the embossments of the top ply.

### Reference Product C

Reference product C was manufactured almost identically to reference product B. The difference is that the bottom ply was pre-embossed with micro-embossments, that is, embossments with a height in a range of 0.1 mm to 1.2 mm. The embossment density of the micro-embossments was 43 embossments/cm².

For none of the reference products A, B, and C, a step of moistening any ply prior to embossing it or any heated embossing roll was used.

### Exemplary Product 1

Exemplary product 1 was manufactured using an embodiment of the method in accordance with the present disclosure and constitutes a tissue paper product in accordance with the present disclosure.

Exemplary product 1 comprises two structured TAD plies. The top ply was embossed with a single height embossing design (using a non-heated embossing roll). The bottom ply was pre-moistened using water, micro-embossed with a heated embossing roller (heated to a steady state temperature in a range of 80° C. to 170° C., and then ply-bonded together with the top ply using glue at tips of the embossments of the top ply.

### Exemplary Product 2

Exemplary Product 2 was manufactured analogously as Exemplary Product 1, but the embossing load on the bottom ply was increased.

### Exemplary Product 3

Exemplary Product 3 was manufactured analogously as Exemplary Product 2, but the step of pre-moistening the bottom ply prior to the heat-embossing was omitted.

The following table summarizes the manufacturing settings for the various Reference Products and Exemplary Products, as well as measurement results for the basis weight (grammage), the thickness, the main directional tensile strength (MDT), the cross directional tensile strength (CDT), the softness, as well as the absorption capacity.

| | | | Embossing | | | | | | |
|---|---|---|---|---|---|---|---|---|---|
| | | | load | Basis | Thickness | MD | CD | | |
| | Heat- | Pre- | bottom ply | weight | (1 sheet) | Tensile | Tensile | Softness | Absorption |
| Product | embossing | moistening | (kg/cml) | (g/m²) | mm | (N/m) | (N/m) | Panel | (g/g) |
| Ref A | N | N | — | 38.1 | 0.53 | 229 | 101 | | 12.4 |
| Ref B | N | N | — | 37.6 | 0.49 | 268 | 132 | 1.5 | 12.5 |
| Ref C | N | N | 46 | 36.3 | 0.53 | 172 | 77 | 1.6 | 12.5 |
| Ex. 1 | Y | Y | 20 | 36.6 | 0.53 | 247 | 114 | 1.5 | 12.0 |
| Ex. 2 | Y | Y | 42 | 36.6 | 0.62 | 192 | 94 | 1.5 | 13.2 |
| Ex. 3 | Y | N | 43 | 36.7 | 0.62 | 184 | 87 | 1.5 | 13.2 |

As the table illustrates, the reference product B (without embossing of the bottom ply) has a lower thickness than reference product A. This is due to the tension required to convey the plies in the converting line. However, reference product B has higher CD and MD tensile strengths than reference product A, respectively. This can be attributed to the lamination glue.

Reference product C (with a micro-embossed bottom ply) has the same thickness as reference product A. An explanation therefore is that the micro-embossing performed on the bottom ply compensates for the loss of thickness due to the tension. However, reference product C has a lower tensile strength than reference product A, due to the mechanical impact of the embossing.

The exemplary products, manufactured using heat-embossing, can either keep the same thickness as a tissue paper product made of two structured TAD plies (but without heat-embossing), while having a higher tensile strength (see the comparison between reference product A and exemplary product 1 in the table), or the thickness can be increased as compared to the reference product C (with a micro-embossed bottom ply), without losing any tensile strength (see the comparison between reference product C and exemplary product 2 in the table). Another benefit associated with the technology of heat-embossing the bottom structured TAD ply is that the properties of the resulting tissue paper product can be adjusted by adjusting the embossing load of the embossing unit with the heatable embossing roll(s). This way, the tissue paper product can be easily tailored to requirements such as higher tensile strength or larger thickness, etc.

The following graphs shows experimental results for the CD tensile strength and the MD tensile strength, comparing reference products A, B, and C with exemplary products 1 and 2.

The following graph compares the softness of exemplary products 1 and 2 and of the reference products A, B, and C.

This graph shows that the softness can be maintained (in comparison to reference products) when relying on heat-embossing the structured TAD ply, while the thickness can be increased.

When comparing the absorption capacity (in g of water per g of cellulose) of the exemplary products 1 and 2 and of the reference products A, B, and C, one finds that the absorption capacity can be increased with an increase of thickness for the products manufactured relying on heat-embossing.

Moreover, the properties of exemplary product 3 are very similar to those of exemplary product 2 (see the table including experimental data included above). Thus, also without a step of moistening being applied to the bottom ply prior to heat-embossing, the discussed benefits are obtained in tissue paper products in accordance with the present disclosure.

It will be apparent to those skilled in the art that various modifications and variations can be made in the disclosed devices and systems without departing from the scope of the disclosure. Other aspects of the disclosure will be apparent to those skilled in the art from consideration of the specification and practice of the features disclosed herein. It is intended that the specification and examples be considered as exemplary only. Many additional variations and modifications are possible and are understood to fall within the framework of the disclosure.

1. A tissue paper product, such as toilet paper or household towel, wherein
the tissue paper product comprises between two and four plies, including at least a first ply and a second ply, the two plies, three plies, or four plies being ply-bonded, optionally using an adhesive such as lamination glue or mechanical bonding, such as edge embossing, to form the tissue paper product, the first ply and the second ply being outermost plies of the tissue paper product,
a grammage of the tissue paper product being in a range of 24 to 50 g/m² if a total number of plies of the tissue paper product is 2, in a range of 34 to 65 g/m² if a total number of plies of the tissue paper product is 3, and in a range of 55 to 95 g/m² if a total number of plies of the tissue paper product is 4, and wherein
the first ply is a structured paper ply, such as a ply made of TAD, UCTAD, eTAD, Atmos, or NTT, and
the first ply has been embossed with a heated first embossing roll.

2. The tissue paper product of claim 1, wherein the first ply comprises micro-embossments with a micro-embossment height in a range of 0.1 mm to 1.2 mm.

3. The tissue paper product of claim 1, wherein the first ply comprises macro-embossments with a macro-embossment height in a range of 0.2 mm to 2.0 mm, optionally 0.8 mm to 1.4 mm,
wherein, optionally, the macro-embossments cover between 1% and 20% of a total surface of the first ply, optionally between 2% and 10%, or between 3% and 6%.

4. The tissue paper product of claim 1, wherein the first ply has been embossed with a heated embossing roll heated to a temperature in the range of 80° C. to 170°, optionally 100° C. to 165°, 110° C. to 165°, 120° C. to 160°, or 130° C. to 155°.

5. The tissue paper product of claim 1, wherein the first ply has been moistened, prior to the step of embossing the first ply, with a liquid, such as water optionally provided with one or several additives, with an amount of liquid being in the range of 2% to 12% of the basis weight of the first ply, or optionally 4% to 10% of the basis weight of the first ply.

6. The tissue paper product of claim 1, wherein the first ply has not been moistened with a liquid prior to the step of embossing.

7. The tissue paper product of claim 1, wherein the second ply is made of Conventional Wet Press paper (CWP) or is a structured paper ply, such as a ply made of TAD, UCTAD, eTAD, Atmos, or NTT.

8. The tissue paper product of claim 7, wherein the second ply has been embossed with a heated second embossing roll.

9. The tissue paper product of claim 1, wherein the tissue paper product comprises exactly two plies, being the first ply and the second ply, wherein the first ply comprises first embossments with a first height (h1), the first height (h1) being in a range of 0.2 mm to 2.0 mm,
the adhesive, such as lamination glue, is optionally applied to tips of the first embossments of the first ply,
the second ply comprises second embossments with a second height (h2), the second height (h2) being in a range of 0.2 mm to 2.0 mm,
the first ply optionally comprises third embossments with a third height (h3) smaller than the first height (h1) (h1>h3), and
the second ply optionally comprises fourth embossments with a fourth height (h4) smaller than the second height (h2) (h2>h4).

10. The tissue paper product of claim 1, wherein the tissue paper product comprises exactly three plies, being the first ply and the second ply and a third ply, located between the first ply and the second ply, the second ply optionally being made of Conventional Wet Press (CWP) paper and/or the third ply optionally being made of Conventional Wet Press (CWP) paper,
the first ply comprises first embossments with a first height (h1), the first height (h1) being in a range of 0.2 mm to 2.0 mm,
the adhesive, such as lamination glue, is optionally applied to parts of the third ply bonded to tips of the first embossments of the first ply,
the second ply comprises second embossments with a second height (h2), the second height (h2) being in a range of 0.2 mm to 2.0 mm,
the first ply, optionally, comprises third embossments with a third height (h3) smaller than the first height (h1) (h1>h3), and
the second ply, optionally, comprises fourth embossments with a fourth height (h4) smaller than the second height (h2) (h2>h4).

11. The tissue paper product of claim 10, wherein the third ply has not been embossed prior to ply-bonding.

12. The tissue paper product of claim 10, wherein the second ply and the third ply have been embossed together to form the second embossments on the second ply and the third ply, and wherein, optionally, the second ply and the third ply have been embossed together to form also the fourth embossments on the second ply and the third ply.

13. The tissue paper product of claim 1, wherein the tissue paper product comprises exactly four plies, being the first ply and the second ply, and a third ply and a fourth ply located between the first ply and the second ply, the second ply and/or third ply and/or the fourth ply optionally being made of Conventional Wet Press (CWP) paper, wherein
the first ply comprises first embossments with a first height (h1), the first height (h1) being in a range of 0.2 mm to 2.0 mm,
the adhesive, such as lamination glue, is optionally applied to parts of the third ply bonded to tips of the first embossments of the first ply,
the second ply comprises second embossments with a second height (h2), the second height (h2) being in a range of 0.2 mm to 2.0 mm,
the first ply optionally comprises third embossments with a third height (h3) smaller than the first height (h1) (h1>h3), and
the second ply optionally comprises fourth embossments with a fourth height (h4) smaller than the second height (h2) (h2>h4).

14. The tissue paper product of claim 13, wherein the second ply and the fourth ply have been embossed together to form the second embossments on the second ply and the fourth ply, wherein
the third ply has not been embossed prior to ply-bonding or has been embossed separately from the first ply, the second ply, and the fourth ply, and
the fourth embossments have, optionally, been formed only on the second ply but not on the fourth ply, or the second ply and fourth ply have, optionally, been embossed together to form also the fourth embossments on the second ply and the fourth ply.

15. The tissue paper product of claim 13, wherein the second ply, the third ply, and the fourth ply have been embossed together to form the second embossments on the second ply, the third ply, and the fourth ply, and,
optionally, the second ply, the third ply, and the fourth ply have been embossed together to form the fourth embossments on the second ply, the third ply, and the fourth ply, or,
optionally, the fourth embossments have been formed on the second ply and the fourth ply, but not on the third ply, or,
optionally, the fourth embossments have been formed on the second ply, but not on the third ply and the fourth ply.

16. The tissue paper product of claim 13, wherein the third ply and the fourth ply have been embossed together separately from the first ply and the second ply, or
wherein the third ply and the fourth ply are unembossed.

17. The tissue paper product of claim 9, wherein the first embossments are provided on an area constituting between 1% and 20% of a total surface of the first ply, and/or a density of the third embossments is in a range of 25 to 120 embossments/cm², optionally 40 to 100 embossments/cm², or 50 to 80 embossments/cm².

18. The tissue paper product of claim 9, wherein the second embossments are provided on an area constituting between 1% and 20% of a total surface of the second ply, and/or a density of the fourth embossments is in a range of 25 to 120 embossments/cm², optionally 40 to 100 embossments/cm², or 50 to 80 embossments/cm².

19. The tissue paper product of claim 1, wherein a grammage of each of the plies is in a range of 13 to 30 g/m², optionally, 16 to 28 g/m², or 18 to 24 g/m².

20. A tissue paper product, such as toilet paper or household towel, wherein
the tissue paper product comprises between two and four plies, including at least a first ply and a second ply, the two plies, three plies, or four plies being ply-bonded, optionally using an adhesive such as lamination glue or mechanical bonding, such as edge embossing, to form the tissue paper product, the first ply and the second ply being the outermost plies of the tissue paper product,
a grammage of each of the plies being in a range of 13 to 30 g/m², optionally 16 to 28 g/m², or 18 to 24 g/m², and wherein
the first ply is a structured paper ply, such as a ply made of TAD, UCTAD, eTAD, Atmos, or NTT, and
the first ply has been embossed with a heated embossing roll.

21. A roll of tissue paper product made of a spirally wound continuous web of the tissue paper product of claim 1, the tissue paper product having a first end and a second end, the web of tissue paper product being wound such as to define an axially extending inner hole centrally positioned relative to the roll and such that the first end is located on the outer side of the roll and the second end is located at the inner hole.

22. The roll of tissue paper product of claim 21, wherein a diameter of the roll is in a range of from 85 to 200 mm.

23. A stack of unfolded sheets or of folded sheets, optionally of interfolded sheets, made of the tissue paper product of claim 1.

24-42. (canceled)

43. A roll of tissue paper product made of a spirally wound continuous web of the tissue paper product of claim 20, the tissue paper product having a first end and a second end, the web of tissue paper product being wound such as to define an axially extending inner hole centrally positioned relative to the roll and such that the first end is located on the outer side of the roll and the second end is located at the inner hole.

44. The roll of tissue paper product of claim 43, wherein a diameter of the roll is in a range of from 85 to 200 mm.

45. A stack of unfolded sheets or of folded sheets, optionally of interfolded sheets, made of the tissue paper product of claim 20.
